(19) United States
(12) Patent Application Publication
(10) Pub. No.: US 2003/0115575 A1
(43) Pub. Date: Jun. 19, 2003

(54) Method and system for sharing resources in hierarchical backplanes

(76) Inventor: David Reyna, San Francisco, CA (US)

Correspondence Address: FAY KAPLUN & MARCIN, LLP, 17th Floor, 100 Maiden Lane, New York, NY, 10038, US

(21) Appl. No.: 10/033,977

(22) Filed: Dec. 19, 2001

(51) Int. Cl. G06F 9/44

(52) U.S. Cl. 717/120

(57) ABSTRACT

The present invention describes a method and system of sharing resources between interconnected software components. The software components can be attached to different backplanes, that are in a hierarchical relationship to one another. The resources are named in the backplanes according to a convention that specifies how to access the resources from any of the backplanes.

### BACKGROUND INFORMATION

Modern electronic devices make intensive use of data generated by the devices themselves or by other devices connected to them. These devices are not limited to computers, but include a variety of much simpler devices that have reduced computing capabilities and capacity to connect with other devices.

The functions performed by these devices can be broken down into functions that are carried out by different modules, which can include different software components or applications being executed by the device. The modules can be used in the overall operation of the device, or may be associated with a specific element or function of the device, such as operating a web server or a display. The software components are each programmed to perform some specific function, and may require information from other components to perform that function and/or may produce information that is needed by other components. The data or function carried out by a component and used by another component is commonly called a resource.

The data transfer between components must be managed and streamlined. In particular, when a component (the consumer) requires data from a resource of another component (the producer), the data request must be correlated with the correct resource, so that the consumer can retrieve the data. This process should be rapid, and require a minimal amount of overhead computational resources from the software component, and from the device as a whole. In some cases, the software components may be physically located on different devices, which are interconnected by a data transfer network.

The function of correlating requests from consumers with resources of the producers is typically carried out by one or more backplane modules. The backplane provides an interface between applications that are resource consumers and applications that are resource producers. The backplane thus is a central element to which are connected a multitude of producers and consumers, such that the backplane can route the requests for data to the correct resource, and return the data to the correct consumer.

In some applications, information or data is requested by a consumer associated with a first backplane, but the resource able to provide the information is associated with a second backplane, connected to the first backplane. These additional backplanes must then be able to refer data from one to the other, and to route data requests and responses to and from the correct resource. One conventional method of achieving this result is to repeat the resources of all the connected backplanes in every one of the backplanes. This method, however, is very resource intensive, and is not practical when the devices have limited resources.

### SUMMARY

According to the present invention, a system and method for accessing shared resources between components connected in a hierarchical configuration is implemented, that substantially obviates one or more of the problems due to limitations and disadvantages of the related art. Additional features of the system and method will be set forth in the description which follows.

To achieve these and other advantages a method for sharing resources between interconnected software components is implemented, that includes providing hierarchically related backplane elements each having a resource database adapted to correlate requests for the resources with access information to the resources. The method also includes registering a portion of the software components with each of the backplane elements, registering descendant backplane elements with corresponding parent backplane elements, and providing in the resource database an identifier for each of the resources. The identifier specifies access information to the resource.

A multi layer hierarchical system for sharing resources between interconnected components is also implemented. The system comprises a plurality of layers forming a hierarchical branching structure, each of the layers having a backplane element. Producer and consumer software components registered with the backplane element of at least one layer are included, as well as resources each associated with one of the producer software components. The system also includes a resource database of each of the backplane elements which correlates requests for the resources from the consumer components with access information to the resources of the producer components. Each of the resources is given an identifier specifying access information to the resource.

### BRIEF DESCRIPTION OF THE DRAWINGS

FIG. 1 is a diagram showing an exemplary embodiment of a multi layer hierarchical system for sharing resources between components according to the invention;

FIG. 2 is a schematic representation of a resource identifier according to the invention; and

FIG. 3 is a flowchart showing the procedure for retrieving access information from an identifier of a resource, according to the invention.

### DETAILED DESCRIPTION

The present invention can be further understood with reference to the following description of preferred exemplary embodiments and the related appended drawings, wherein like elements are provided with the same reference numerals. Although the exemplary embodiment shown in the drawings includes a principal backplane layer and two descendant backplane layers, it will be understood by those skilled in the art that additional descendant layers and additional branches of layers may be included in the system, without departing from the scope of the invention. Although the principal backplane layer is shown within a device and the descendant layers are shown outside the device, different arrangements where additional backplanes are situated in the same device are also within the scope of the invention is further described below.

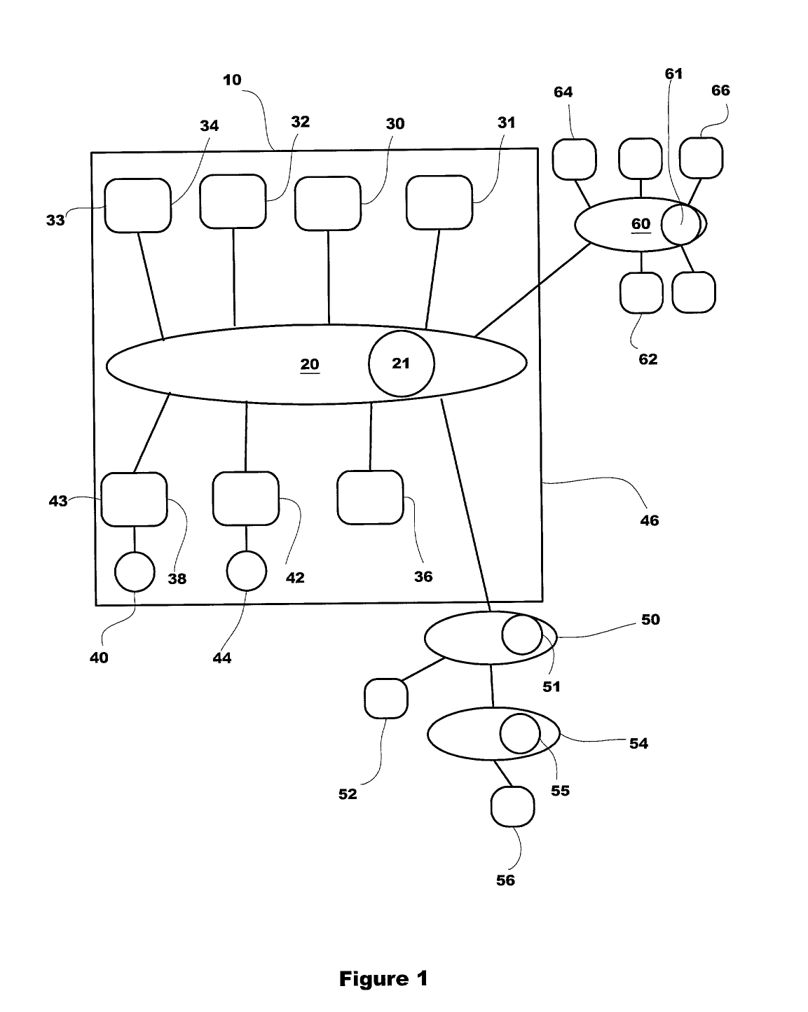

FIG. 1 shows a system for sharing resources between interconnected software components, according to an exemplary embodiment of the invention. In this example, a device 10 includes a backplane 20 to which several software components are connected. In one example, device 10 may be an embedded device that generates data and allows access to the data via a connection to a data network. The device may be a wireless telephone, a Personal Digital Assistant, a networking switch, a router, a gateway, or another embedded device. The data network can be, for example, the Internet.

Backplane 20 includes, for example, a set of modules providing an interface between applications that access resources and applications that contain or own resources. For simplicity, applications that contain resources are referred to as data producers 43, shown below the backplane 20 in FIG. 1. Applications that require resources are referred to as data consumers 33, shown above backplane 20. It should be noted that any of the software components may be either producers, consumers or both, even within the same transaction. FIG. 1 thus is a simplification of the actual relationship between components, used here to provide descriptive clarity.

Backplane 20 also may include a database 21 having a resource database module containing entries that provide a mapping or correlation between data references contained in requests for resources received from data consumers 33, and access routines that obtain data from data producers 43. Database 21 also may have a component list module where identification and contact information is stored for the components. To perform this mapping, backplane 20 must know where to look for the resource requested by the data consumers 33, particularly in the case where the resource is associated with another backplane, hierarchically dependent form backplane 20. In the exemplary case where backplane 20 is part of an embedded device 10, the data producer components may include, for example, the code or application that reads data from various sensors of the device or from a database of the device. The data consumer components may include an applet server, an HTML server, or other components that allow communication with applications outside the device.

With reference to FIG. 1, several consumer software components are shown connected to backplane 20, including a Command Language Interface (CLI) component 34 for Telnet communications, an HTML web server 32, a Java Applet server 30 and a SNMP agent 31 used for network functions. Each of these software components principally requests data from the system, although in some cases data may be provided to the system by these components. Data producer software components are also connected to backplane 20. For example, an RM Producer 38 may be connected to the backplane 20, and may include a memory database 40 containing data that may be used by another software component. An SNMP object 42 with database memory 44 and a glue code component 36 may also be connected to backplane 20 as producers, since during normal operations they primarily provide rather than request data to the system. As described below, producer applications register with the backplane to which they are connected when their resources become available to the network. Similarly, consumer applications register with their backplane to be allowed to access network resources.

In addition to the software components described above, backplane 20 may be connected to additional backplanes which, in turn, may be connected to their own set of software components. In this configuration, one example of which is illustrated in FIG. 1, the backplanes form a hierarchical tree with “parent” backplanes from which branch one or more “descendant” backplanes connected to the parent, forming a first layer of descendance. From each of the descendant backplanes may branch a second layer of descendant backplanes. Each backplane in the second layer is directly connected to a backplane in the first layer, and indirectly connected to the initial parent backplane. A hierarchical structure is thus formed, with an arbitrary number of layers branching from a parent backplane.

In the exemplary embodiment of FIG. 1, from parent backplane 20 branches a first layer containing descendant backplane 50, and a second layer containing descendant backplane 54. Backplane 54 is a direct descendant of backplane 50. The diagram shows only one backplane 20 within device 10, but additional backplanes may be located in the same device. In the example of FIG. 1, backplane 20 is also a descendant backplane for a hierarchically superior layer, which includes a backplane 60 complete with its own database 61, consumer applications 64, 66 and producer applications 62.

As in the case of the software resources described above, the pairings of parent and descendant backplanes also may be registered, so that the resources registered with each backplane will be available to all other backplanes. For example, each descendant backplane together with its associated components and sub-layers is normalized as a single entity, and may be registered as a producer for the backplane hierarchically above it. Similarly, each parent backplane and associated components is normalized and may be registered as a single consumer for the backplane hierarchically below it.

When a user such as a consumer software component seeks to access a resource, the user only needs to know the appropriate naming convention that identifies the resource. The system according to the invention provides access to resources that belong to components connected to any backplane, from other components that are connected to different backplanes. In this manner, it is not necessary to repeat the resources in the various multiple layers of backplanes, but it is only necessary to know the appropriate naming convention that identifies the access path to the resource. The name of the resource thus describes in which hierarchically related backplane the resource is located.

According to the exemplary embodiment of the invention, any of the software components and their associated resources may join or leave the system for sharing resources at any time. This is possible by requiring the software components to register with the backplane to which they are connected when they want to be part of the sharing system, and to de-register when they want to terminate their participation. More specifically, components have to register with the backplane before they are allowed to make backplane calls to access resources. The components also have to de-register before they are unloaded from the system, so that their registered functions or resources become inaccessible from the backplane. A dynamic portion of the backplane resource database 21 contains information for the components that may register and de-register at will. A static portion of the resource database may also be provided, containing data for permanently registered components.

When a component is registered with the backplane, it is added to the component list in database 21 of backplane 20. The component list entry for the component will include information to identify the component within the system, and also contact information for the component, such as callback functions and IPC addressing information. In the case of software components that are data producers, their resources also must be included in the resource database portion of database 21. The information recorded for each resource includes the name of the resource, its type, and any information necessary to access the resource. These two aspects of the backplane database 21 can be carried out in separate memory structures, or within the same memory structure. It will also be clear to one of skill in the art that the same registration and de-registration process is carried out in all backplanes in the system, such as backplanes 60, 50 and 54, and their respective databases 61, 51 and 55.

According to the preferred embodiment of the present invention, the backplanes themselves are registered and de-registered with their respective parent and descendant backplanes. The registration for backplanes is carried out in a manner similar to the manner described for software components, so that no additional steps have to be carried out by the parent backplane. This is possible because, as explained above, the backplanes, their registered software components, and their registered descendant backplanes are normalized and treated as a single consumer or producer component. In this manner, devices, components and resources may join or leave the system without having to change the configuration of the entire system, but only the information in the resource database of one backplane. For example, a backplane-2 hierarchically below a backplane-1 may be registered as a producer. The name of backplane-2 is listed in the component list of backplane-1 as a producer, and the developer configuring the system may instruct backplane-1 to forward any request for a resource having the appropriate prefix to backplane-2. The resource database of backplane-1 does not have to list all the resources of backplane-2, but may simply provide a mapping to backplane-2 for any data reference having a prefix corresponding to backplane-2. Those data references are then resolved within backplane-2, and the proper resource is accessed based on the portion of the data reference beyond the prefix, according to a naming convention that will be fully described below. The events within backplane-2 are transparent to backplane 1, and after the resource is accessed in backplane-2, the results are returned to backplane-1 in the same manner as if backplane-2 was simply a producer component. This process may be repeated for several layers of backplanes, such that the resource access steps taking place below any one layer are transparent to that layer.

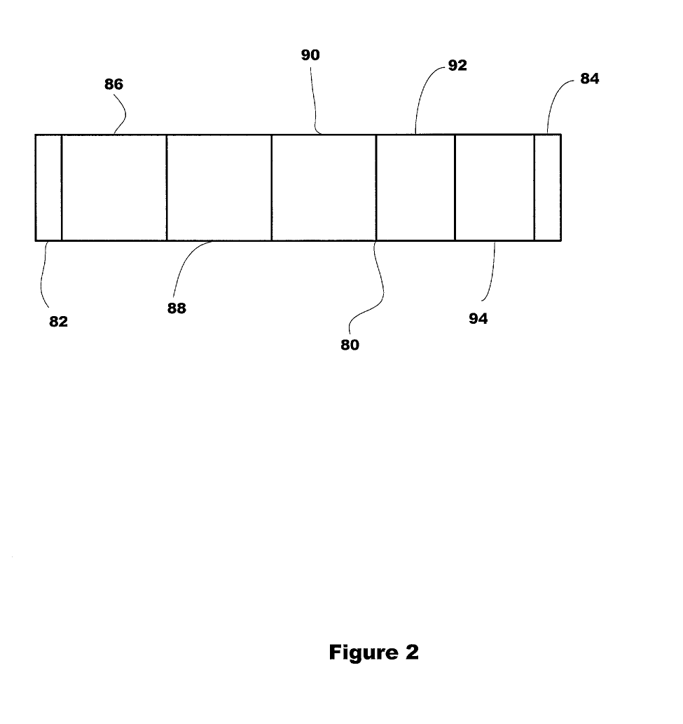

An important aspect of accessing the resources located in different hierarchical layers and of directing the data generated by the resources to the requesting component is to use an identifier of the resources that contains sufficient information for the system to find the resource. A naming convention including the required information is thus used. FIG. 2 shows schematically an exemplary embodiment of the naming convention used in the preferred embodiment. Identifier 80 is assigned to a resource when it is registered with a backplane. The identifier is also expanded at that time, as will be described below, so that the resource will be available to all the upper hierarchic backplanes above the backplane where the registration takes place. The name of the resource may be provided by the resource developer, either to indicate the function of the resource, or following some industry standard naming. The parts of identifier 80 that indicate the path where the resource can be located are assigned by the backplane logic when the resource is registered with the backplane. For example, the producer owning the resource may provide the backplane with information on the producer's data structure, so that a complete identifier 80 may be associated by the backplane with that resource.

The naming convention described with reference to FIG. 2 takes into account whether the resource is “local”, meaning that it is owned by a component connected directly to the backplane where the registration takes place, or whether it is owned by a component connected to another backplane, hierarchically related to the backplane where the name is registered. For local resources, the naming can be simpler, since it does not need to specify in which backplane the resource can be found.

The ability to access resources such as databases that are physically located in software components that may be registered with different backplanes confers certain advantages. For example, a load-sharing scheme may be implemented, whereby the consumers of resources can address their requests to the specific database that is most likely to contain the data, simply by appropriately naming the data with a name that pinpoints that database. The system then processes the name, and using the hierarchical relationships between backplanes and databases, accesses the data, without requiring additional work from the consumer. According to this scheme, the data may be placed on many small, fast databases, rather than one or a few larger, slower databases. In addition, as will be described fully below, access speed can be enhanced where multiple processes or protection domains are employed in a single device.

According to exemplary embodiments of the present invention, databases can be created that appear to the consumers to be a single, unified database, which may be accessed without additional computing overhead from the consumer. In reality, however, the data or other resources are spread over databases that extend across internal domains and devices that use the same hierarchical structure. The system processes the requests for data and accesses the correct database using the information provided by the naming convention of the resources being sought. In one example, the various databases that form the apparent monolithic database may be registered with each other as both producers and consumers. As described above, backplane-2 may be registered with backplane-1 as a producer, indistinguishable by backplane-1 from any other type of producer software component. In turn, backplane-1 may register with backplane-2 as a consumer, appearing in the component list of backplane-2 as any other consumer. Backplane-2 would thus not know if a request for a resource received from backplane-1 originated from backplane-1, from a consumer software component registered with backplane-1, or from another backplane registered as a consumer with backplane-1. Backplane-2 simply processes a request for a resource received from one of its registered consumers, and any further transactions taking place within backplane-1 are transparent to backplane-2.

When a resource is registered, the identifier 80 it is given may include a beginning character 82 and an ending character 84. These characters are used to delimit the name, and facilitate recognition of the resource name by the system. For example, characters 82, 84 may include /, %, $, or other characters not normally used by the system. As shown in FIG. 2, field 86 is a SystemInfo field, which is optional. For example, SystemInfo field 86 may be omitted by the developer if the resource is expected to be only used within the backplane where the resource is registered. Field 86 specifies the name of the backplane to which the component owning the resource is connected. This backplane may be one of alternate backplanes within a device, or a backplane external to the device. In addition, field 86 may contain information on how to reach an external host of the backplane, for example by specifying a descendance chain. The descendance chain lists the names of all the backplanes that are found in the hierarchical layers between the parent backplane where the name of the resource is registered, and the descendant backplane where the resource is actually located. The descendance chain is thus like a roadmap that directs the parsing engine of the system to the resource being identified, by indicating which parent and descendant backplanes must be contacted to reach the software component having the resource.

If the SystemInfo field 86 is not specified, the parsing engine will use a context-based default system info name to access the resource. For example, the default name may include a descendance chain pointing back to the backplane of the software component requesting the resource.

Field 88 is a Pathname field, which specifies the registered name of the producer component that owns the resource. Field 88 is optional, and the developer may omit it if the resource is expected to be used only by a default producer. If fields 86 and 88 are not specified, the resource name is unqualified, and a backplane receiving a request for that resource will route it to a default backplane and producer component, according to the context where its resource is specified. A fully qualified name contains sufficient fields to locate the resource anywhere within the system. This ability allows developers of the system to use local resource names without knowing the registration names of the producers hierarchically above, and is especially useful when the producer name is allocated dynamically at run time. For example, if an unqualified request is received in a backplane “A”, the system according to the present invention will initially search for the resource in that same backplane “A”. More generally, if a resource identifier does not specify a backplane name, a default backplane name is used, which may be the backplane that received the request containing the resource identifier.

Field 90 is a required field, and indicates the name of the resource. Field 90 must be completed whether the resource name is unqualified, for a local resource, or the name is fully qualified, for a resource located on another backplane. It should be noted that special characters may be used to separate the various components of the resource name. For example, field 86 may start with // and end with /. Other symbols not generally used in the resource names, such as * and ˆ , may be used to delimit fields 86, 88, 90 and other fields.

Identifier 80 may include a method field 92 and an instance field 94. Method field 92 allows users to define method calls to be attached to the variable handled by the backplane. The method calls are used like any other backplane variable, but can only be used in a GET command. Instance field 94 is used to specify a member or a table, and/or to pass string arguments to resources that support them. Instance field 94 may be specified either as an IOD instance or a string argument instance. In one exemplary embodiment according to the present invention, the identifier may have the following form:

//wmb_a/slot1/Ethernet1040/Name-22ˆ printf(“%10d”)

In this example, //wmb_a/ is the SystemInfo specifying the name of the backplane where the resource may be found. The field slot1/Ethernet1040/ specifies the Pathname to producer slot1 and sub-producer Ethernet1040 who owns the resource. Name-22 is the name of the resource specified, owned by sub-producer Ethernet1040. The method call ˆ printf(“%10d”) is attached to the resource name, and may also include the string argument instance “%10d” that specifies a string argument to the resource.

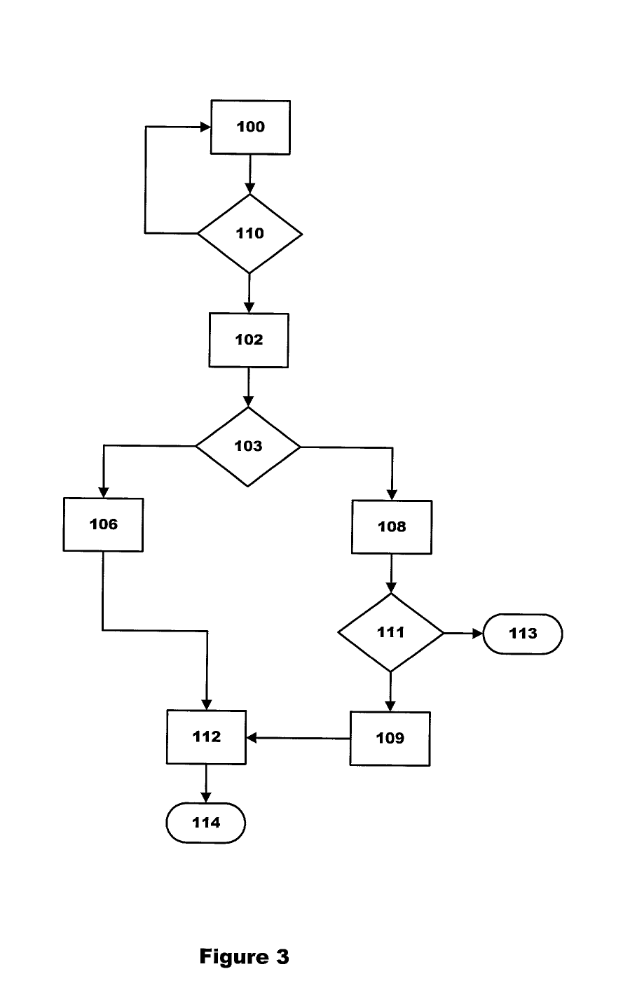

An example of the procedure followed to correlate a resource name to the actual resource is described with reference to FIG. 3. In this example, the name is registered as fully qualified, meaning that SystemInfo field 86 and Pathname field 88 are specified. However, it is also possible for a producer to register a wildcard resource name, informing the backplane that further parsing of the name must be deferred for matching names to that producer. When wildcard naming is used, the system will search for the specified resource in multiple backplanes, according to a priority scheme that may be specified by the developer.

In step 100, the SystemInfo field 86 is stripped from the identifier, and the remaining portions of the resource identifier are passed on to the specified backplane host. According to one embodiment of the invention, producers are allowed to register their resources with an optional alternate name. If the resource name has an alternate name, then that name is used in place of the original resource name in step 110, and the lookup continues in step 100, as described above. Any circular reference loops created by alternate names are detected at this stage.

In step 102, the rest of the identifier, including Pathname field 88, name field 90 and method field 94, is used as an hash key, and the name is looked up in the hash table of the resource database for the specified or default backplane. Step 103 determines whether the fully qualified name can be found at this stage. If it is found, the appropriate fields are filled in step 106, and the name is sent to the producer component owning the named resource, so that parsing can be completed in step 112.

If the qualified name is not found, a wildcard matching is performed. In step 108 each successive part of the path name is added, until a match is found in subsequent step 111. If a match is found, the name is completed with the newly determined parts of the name in step 109, so that the producer component may complete the parsing in step 112. Once parsing is completed in step 112, the resource is accessed in step 114, and the requested data is made available. If no match is found, it is assumed that the name is erroneous, and parsing stops in step 113.

Resources according to this exemplary embodiment of the invention may be applications that perform some function, or may be data stored in a memory device, such as memories 40, 44 of FIG. 1. The data resources may be scalar, where the data has only one value associated with it. In this case, no indexing information is required to access the resource. Alternatively, the data resource may be tabular, where the variables are in a matrix form. In this case, indexing information must also be passed to the correct backplane, so that the appropriate value of the variable may be accessed. This indexing information may be included in the naming convention described above, or may be conveyed separately.

As described above, embodiment s according to the present invention include several software producers, such as databases, which are registered with different backplanes, and may be located on different devices. The consumer, however, only interacts with what appears to be a single database, while the system according to the invention manages links across network sockets, Remote Procedure Calls (RPC) or any other inter-device communication protocols that tie the various devices together.

The ability to access data or resources across separate hierarchical backplanes is especially useful when there is a time penalty in communicating between applications. For example, this is the case when resources are located across different processes of protection domains, so that the communications must go over an Inter Process Communication (IPC) link or protection switch. The link uses overhead computing power, and may require asynchronous two way messages rather than direct invocation. In the preferred embodiment according to the invention, the database may reside in the different processes of protection domains, and the system may reduce overhead by grouping transactions across the IPC link or protection switch, and may manage the asynchronous communication internally so that the consumer does not have to provide extra instructions to do so.

In another embodiment according to the invention, the software components connected by the data network can register as event consumers, in addition to being data producers and consumers. In this case, instead of a request for data, the backplane receives a request for notification of the occurrence of an event. The request for notification is treated as described above, similarly to the request for data, and a notification is sent to the requestor. Since data and event notification requests are handled similarly, the same components can be both data and event consumers and/or producers. An event consumer may also register with the backplane like a regular consumer, and additionally specifies of what event occurrence it wants to be notified.

In one exemplary embodiment according to the present invention, the event consumers register with a backplane, such that they appear in the backplane's component list as event consumers. In addition, the event consumer registers with the backplane a list of events for which notification is sought, in a manner similar to the registration of resources by a producer. An event handler is also registered with the backplane, and may be listed in the resource database of the backplane, or in a different database. In the preferred embodiment according to the present invention, event producers are not specifically registered with the backplane, since a list of events of interest is provided by the event consumers during their registration process. However, registration of event producers may be implemented, for example to assist in development and debugging of the system.

Although the invention has been described with reference to an embodiment having one device and four layers of hierarchic backplanes, it will be apparent to those skilled in the art that different embodiments including additional devices and more or fewer layers can be addressed by the method and system of the invention. It will also be apparent to those skilled in the art that various modifications and variations can be made in the structure and the methodology of the present invention, without departing from the spirit or scope of the invention. Thus, it is intended that the present invention cover the modifications and variations that come within the scope of the appended claims and their equivalents.

What is claimed is:

1. A method of sharing resources between interconnected software components through hierarchically related backplane elements, comprising:
providing a resource database for each of the hierarchically related backplane elements, the resource database being configured to correlate requests for the resources with access information to the resources;
receiving in each of the backplane elements registrations for at least a portion of the software components;
registering descendant backplane elements with corresponding parent backplane elements, and registering parent backplane elements with corresponding descendant backplane elements; and
providing in the resource database of each of the backplane elements an identifier of each of the resources, the identifier specifying access information to the resource.

2. The method according to claim 1, further comprising registering each of the descendant backplane elements as a producer with the corresponding parent backplane element.

3. The method according to claim 1, further comprising registering a portion of the software components with each of the backplane elements as at least one of a producer and a consumer.

4. The method according to claim 3, further comprising registering each of the software components and each of the descendant backplane elements as at least one of a data consumer, data producer, event consumer and event producer.

5. The method according to claim 1, further comprising registering each of the parent backplane elements with the corresponding descendant backplane elements as a consumer.

6. The method according to claim 1, wherein the step of providing the identifier for a resource owned by a software component comprises:
determining a name of the backplane element to which the software component is registered;
determining a descendance chain of the backplane element;
determining a name of the software component that owns the resource;
determining a name of the resource; and
creating the resource identifier as a sequence of at least one of the descendance chain, backplane element name, software component name and resource name.

7. The method according to claim 1, wherein the step of registering the descendant backplane elements further comprises listing a name of the descendant backplane element as a producer in a component list of the parent backplane, and providing a mapping to the descendant backplane in the resource database of the parent backplane.

8. The method according to claim 6, further comprising creating the identifier including a blank backplane element name when the backplane element is a default backplane element, and creating the identifier with a blank descendance chain when the descendance chain is a default descendance chain.

9. The method according to claim 8, wherein the default backplane element name corresponds to a backplane element receiving the identifier.

10. The method according to claim 8, wherein the default descendance chain corresponds to a descendance chain of the backplane element receiving the identifier.

11. The method according to claim 1, further comprising de-registering selected resources from backplane elements where the selected resources are registered.

12. The method according to claim 1, further comprising de-registering selected descendant backplane elements from the corresponding parent backplane elements.

13. A multi layer hierarchical system for sharing resources between interconnected components, the system comprising:
a plurality of layers forming a hierarchical branching structure, each of the layers having a backplane element;
producer and consumer software components listed with the backplane element of at least one layer;
resources each associated with one of the producer software components; and
a resource database of the backplane element, the resource database correlating requests for the resources from the consumer components with access information to the resources of the producer components, each of the resources having an identifier specifying access information to the resource.

14. The system according to claim 13, wherein each of the resources is registered with the backplane element of at least one layer.

15. The system according to claim 13, wherein each of the components is listed with the backplane element of at least one layer.

16. The system according to claim 15, wherein each of the resources is registered with the backplane element in which the associated producer component is listed.

17. The system according to claim 13, wherein the identifier is formed at least in part from names of parent layers of the backplane element, a name of the backplane element in which the producer software component is listed, a name of the associated producer component, and a name of the resource.

18. The system according to claim 17, wherein the identifier is further formed at least in part from a method call associated with the resource and an instance reference of the resource.

19. A method of accessing a resource of a network, comprising:
receiving a resource identifier from a consumer software component associated with a consumer backplane;
parsing the resource identifier to determine a location of the resource in the network;
accessing a producer software component at the determined location, the producer software component having the resource; and
providing an output of the resource to the consumer software component.

20. The method according to claim 19, wherein the resource identifier comprises a descendance chain of a producer backplane having the resource, a name of the producer software component, and a name of the resource.

21. The method according to claim 19, wherein the accessing step further comprises the steps of:
sending the resource identifier to a producer backplane being determined from the resource identifier, the producer software component being registered with the producer backplane; and
accessing the producer software component from the producer backplane.

22. A system comprising:
a first backplane having a first backplane identifier, the first backplane including
a component data structure configured to store component names related to components accessible via the first backplane, the components having resources;
a resource data structure configured to store mappings corresponding to resource identifiers of resources accessible via the first backplane;
a backplane control module including a parser configured to determine a resource location based on the resource identifiers; and
a second backplane having a second backplane identifier, wherein the second backplane identifier is included in the component data structure, and wherein mappings corresponding to second backplane resource identifiers of resources accessible via the second backplane are included in the resource data structure.

23. The system according to claim 22, wherein the parser is configured to locate resources by correlating the resource identifiers with location data of the resource data structure.

24. The system according to claim 22, wherein the parser is configured to locate resources of the second backplane by correlating the second backplane resource identifiers with location data of the resource data structure.

25. The system according to claim 24, further comprising a second backplane resource data structure of the second backplane configured to provide a parser of the second backplane with mappings to resources identified by the second backplane resource identifiers.
